(19) United States
(12) Patent Application Publication
(10) Pub. No.: US 2024/0365411 A1
(43) Pub. Date: Oct. 31, 2024

(54) METHOD AND APPARATUS FOR USER PRESENT EVENTS WITH CACHED PRE-AUTHORIZATION BLUETOOTH ® LOW ENERGY (BLE) SECURE PAIRING MECHANISM

(71) Applicant: Dell Products, LP, Round Rock, TX (US)

(72) Inventors: Kai Leong Wong, Singapore (SG); Manish Krishnaji Desai, Singapore (SG)

(73) Assignee: Dell Products, LP, Round Rock, TX (US)

(21) Appl. No.: 18/139,609

(22) Filed: Apr. 26, 2023

(51) Int. Cl. H04W 76/14; G06F 1/3203

(52) U.S. Cl. CPC H04W 76/14; G06F 1/3203

(57) ABSTRACT

An information handling system includes a hardware processor executing computer readable program code of a user presence detection system to detect interactions of a user with the information handling system to determine pairing priority. Further, the hardware processor executes computer readable program code of a pre-authorization security exchange system to communicate with a wireless peripheral device to receive or generate pre-authorization passcode entry information and to initiate a security exchange communication to authorize Bluetooth® (BT) pairing pending a user decision to accept the pairing to reduce pairing time. The pre-authorization security exchange system stores the pre-authorization passcode entry information in a memory device for authorization or for a later retry and, if authorized and pairing accepted, a wireless interface adapter will BT pair the information handling system and the wireless peripheral device.

### FIELD OF THE DISCLOSURE

The present disclosure generally relates to Bluetooth pairing of a peripheral device with an information handling system. The present disclosure more specifically relates to pre-authorizing Bluetooth® low energy (BLE) secure pairing to minimize pairing delay.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling needs and requirements vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. Furthermore, information handling systems may be operatively coupled to, via a pairing process, various peripheral devices that allow a user to interact with the information handling system.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system and a wireless peripheral device (PD) including a pre-authorization security exchange system used to engage in a pre-authorization custom security exchange handshaking process with a wireless PD to pair the information handling system to the wireless PD according to an embodiment of the present disclosure;

FIG. 2 is a graphic diagram of an information handling system pairable with a wireless peripheral device using a pre-authorization security exchange system according to an embodiment of the present disclosure;

FIG. 3 is a process flow diagram of a method of querying, verifying, and Bluetooth® pairing a wireless peripheral device to an information handling system using the cached pre-authorization security exchange system according to an embodiment of the present disclosure; and

FIG. 4 is another process flow diagram of a method of querying, verifying, and Bluetooth® pairing a wireless peripheral device to an information handling system using the pre-authorization security exchange system according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Information handling systems operate to provide computing, data storage, and application resources among other computing resources. A plurality of peripheral devices may be operatively coupled, wirelessly, to the information handling system such as via a Bluetooth® (BT) wireless protocol. The wireless peripheral devices allow the user to interact with the information handling system by receiving output and proving input to the information handling system. Some peripheral devices may serve as both input and output devices. Although some peripheral devices may have a wired connection with the information handling system, wireless peripheral devices are operatively coupled to the information handling system via a radio of a wireless interface adapter in the information handling system and a radio located within the wireless peripheral devices, for example BT wireless systems. In order to allow for the operative coupling of a wireless peripheral device to the information handling system, the wireless peripheral device may initiate a pairing process. This pairing process includes security protocols that securely couple the wireless peripheral device to the information handling system. In some instances, this pairing process requires user input to initiate the pairing process (e.g., not being automatic). The pairing process, including the exchange of security protocol data, does not initiate until the user has provided input to the information handling system indicating that the pairing process should continue. Waiting on the user to provide this confirmation to pair with the information handling system with the peripheral device may increase the time required to conduct such pairing and cause the user to wait for generation of pre-authorization passcode entry information, a security exchange verification, and pairing request exchange of a session key before pairing succeeds. This may provide for a negative user experience because of the delay.

The present specification describes an information handling system that includes a hardware processor, a memory device, and a power management unit (PMU) to provide power to the hardware processor and memory device. The information handling system may be available to pair with a wireless peripheral device (PD) when the user has confirmed the pairing process. In order to reduce the time consumed during this process, the information handling system may create pre-authorization passcode entry information prior to the user confirming that the pairing process may proceed. This pre-authorization passcode entry information may also be generated or stored in parallel at the wireless peripheral device. In an embodiment, the hardware processor executing computer readable program code of a user presence detection system may detect interactions of a user with the information handling system to pre-select which among several information handling systems may be intended to pair with the peripheral device using the pre-authorization security exchange system. The hardware processor also executes computer readable program code of the pre-authorization security exchange system to communicate with a wireless peripheral device to initiate a security exchange communication and receive pre-authorization passcode entry information used to operatively couple the wireless peripheral device with the information handling system having a counterpart pre-authorization passcode entry information prior to or in parallel with the user providing input to the information handling system to accept the pairing of the wireless peripheral device with the information handling system. In some instances, the user may provide input to the information handling system to proceed with the pairing process upon which the generated pre-authorization passcode entry information has already begun and the pre-authorization security exchange and the pairing agent system proceed with the remaining steps of the pairing process to pair more quickly than previous system that require waiting while a user enters a code. Further, where the user presence has been detected, but input indicating that the pairing process decision has not been received from the user, the pre-authorization security exchange system may begin generating the pre-authorization passcode entry information and start the pre-authorization security exchange. The pre-authorization security exchange system may then pair when acceptance of the pairing was received. If acceptance is not received, the system may store the pre-authorization passcode entry information in the memory device for later use in the pairing process when the user is available to provide this acceptance input to the information handling system. In an embodiment, the memory device may be a secure memory device used to securely maintain authorization passcode entry information.

In an embodiment, the hardware processor may execute computer readable program code of the user presence detection system to detect the presence of a user operating the information handling system to determine that a user has interacted with the information handling system within a threshold time limit. This threshold time limit may be used to assure that the user was, at least until recently, actively engaged with the information handling system and may be available to provide input to accept the pairing of the information handling system with the wireless PD. This is used to indicate that the recently-used information handling system may be intended for peripheral device pairing and it receives priority to pair using the pre-authorization security exchange over other potential pairing information handling system potentially saving additional wait time. In an embodiment, upon detection that the user has interacted with the information handling system within the threshold time limit and input from the user has not indicated that pairing the information handling system with the wireless peripheral device is accepted, the pre-authorization security exchange system may begin to generate the pre-authorization passcode entry information and also start the pre-authorization security exchange and then pair when acceptance of the pairing was received. If acceptance is not received, the system may store the pre-authorization passcode entry information in the memory device for later use when input from the user indicating that pairing the information handling system with the wireless peripheral device is accepted. In an embodiment, upon detection that the user has interacted with the information handling system within the threshold time limit and input from the user has indicated that pairing the information handling system with the wireless peripheral device is accepted, the pre-authorization security exchange system accesses the stored pre-authorization passcode entry information in the memory device and the pre-authorization security exchange will have begun in parallel to the user's acceptance to reduce time delay in pairing the information handling system with the wireless peripheral device.

In an embodiment, the hardware processor may execute the pre-authorization security exchange system to access the detected interactions of a user with the information handling system and determine whether to allow for an initiation of pre-authorization security exchange for verification of the counterpart pre-authorization passcode entry information before pairing and the operative coupling of the wireless peripheral device to the information handling system. In an embodiment, the pre-authorization security exchange system may request for and detect a received signal strength indicator (RSSI) from the wireless peripheral device to determine whether the wireless peripheral device is within a threshold distance from the information handling system to conduct the pre-authorization security exchange for authorization and wireless operative coupling of the wireless peripheral device with the information handling system.

In an embodiment, the pre-authorization security exchange system may receive pre-authorization passcode entry information from the wireless peripheral device and conduct the security exchange communication in parallel with an automatic peripheral device pairing agent displaying, on a video display device of the information handling system, a graphical user interface (GUI) presenting options for the user to input the indication of accepting the pairing of the wireless peripheral device with the information handling system or aborting the pairing of the wireless peripheral device. This will reduce wait time for the security exchange information and avoid requiring the user to manually confirm passcode entry information.

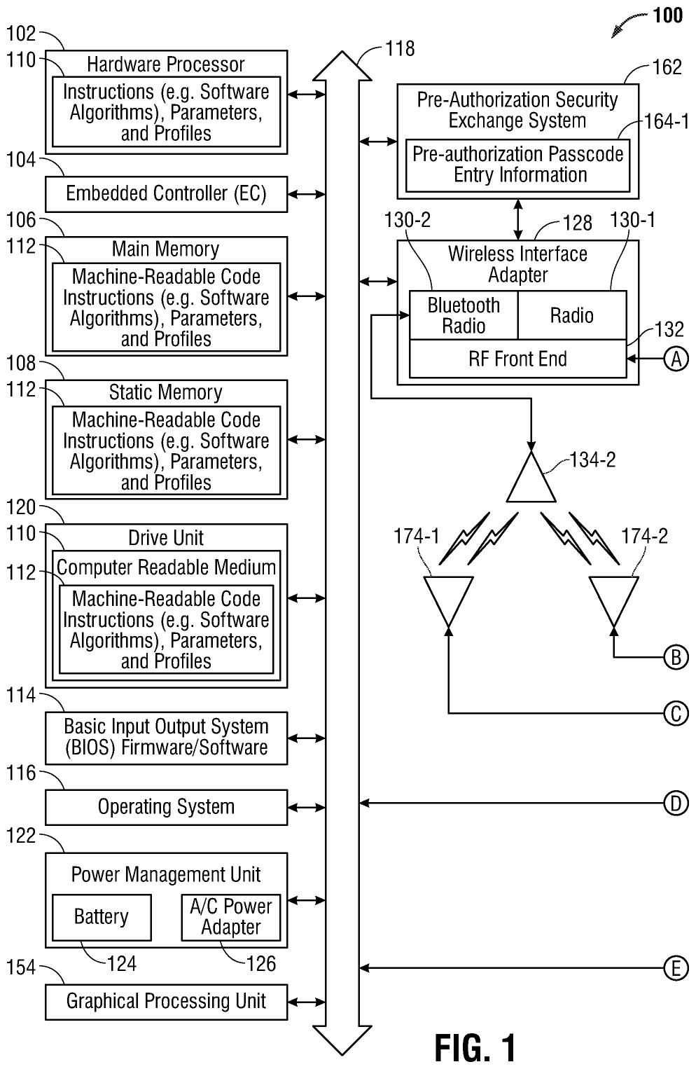

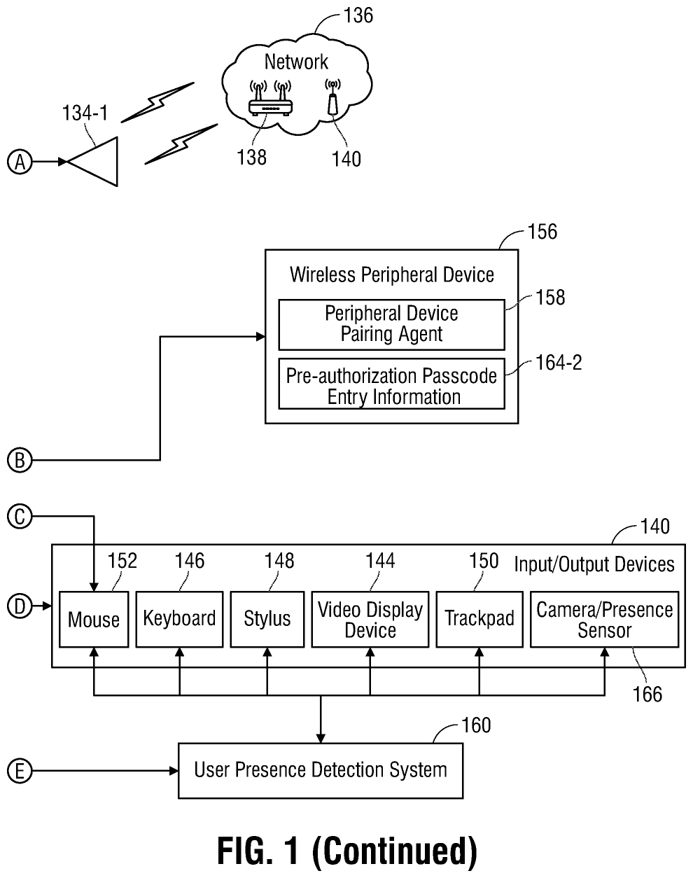

FIG. 1 illustrates an information handling system 100 similar to information handling systems according to several aspects of the present disclosure that is operatively couplable to a wireless peripheral device as described herein. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 can be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a convertible laptop, a tablet, a smartphone, a communications device, an access point (AP), a base station transceiver, a wireless telephone, a control system, a camera, a scanner, a printer, a personal trusted device, a web appliance, or any other suitable machine capable of executing a set of instructions (sequential or otherwise) that specify actions to be taken by that machine, and can vary in size, shape, performance, price, and functionality.

In a networked deployment, the information handling system 100 may operate in the capacity of a server or as a client computer in a server-client network environment, or as a peer computer system in a peer-to-peer (or distributed) network environment. In a particular embodiment, the computer system 100 can be implemented using electronic devices that provide voice, video, or data communication. For example, an information handling system 100 may be any mobile or other computing device capable of executing a set of instructions (sequential or otherwise) that specify actions to be taken by that machine. In an embodiment, the information handling system 100 may be operatively coupled to a server or other network device as well as operatively coupled to or “paired” with any wireless peripheral devices. Further, while a single information handling system 100 is illustrated, the term “system” shall also be taken to include any collection of systems or sub-systems that individually or jointly execute a set, or multiple sets, of instructions to perform one or more computer functions.

The information handling system 100 may include memory (volatile (e.g., random-access memory, etc.), nonvolatile (read-only memory, flash memory etc.) or any combination thereof), one or more hardware processing resources, such as a central processing unit (CPU), a graphics processing unit (GPU) 152, an embedded controller (EC) 104, a hardware processor 102, hardware controllers, or any combination thereof. Additional components of the information handling system 100 can include one or more storage devices, one or more communications ports for communicating with external devices, as well as various input and output (I/O) devices 140, such as a keyboard 144, a mouse 150, a video display device 142, a stylus 146, a trackpad 148, a camera or other sensors 154, or any combination thereof. The information handling system 100 can also include one or more buses 116 operable to transmit data communications between the various hardware components described herein. Portions of an information handling system 100 may themselves be considered information handling systems and some or all of the I/O devices 140 may be wired or wireless.

Information handling system 100 can include devices or modules that embody one or more of the devices or execute instructions for the one or more systems and modules described above, and operates to perform one or more of the methods described herein. The information handling system 100 may execute machine-readable code instructions 110 via the described hardware processing resources that may operate on servers or systems, remote data centers, or on-box in individual client information handling systems according to various embodiments herein. In some embodiments, it is understood any or all portions of machine-readable code instructions 110 may operate on a plurality of information handling systems 100.

As described herein, the information handling system 100 may include hardware processing resources such as a hardware processor 102, a central processing unit (CPU), accelerated processing unit (APU), an EC 104, a neural processing unit (NPU), a vision processing unit (VPU), an embedded controller (EC), a digital signal processor (DSP), a GPU 152, a microcontroller, or any other type of hardware processing device that executes code instructions to perform the processes described herein. Any of the hardware processing resources may operate to execute code that is either firmware or software code. Moreover, the information handling system 100 can include memory devices (volatile (e.g., random-access memory, etc.), nonvolatile (read-only memory, flash memory etc.) such as main memory 104, static memory 106, and drive unit 118 or any combination thereof having computer readable medium 108 storing instructions 110 of computer executable program code. These memory devices may be accessed by any of the hardware processors described herein to access computer-readable program code of a pre-authorization security exchange system 162, user presence detection system 160, or an operating system Bluetooth® (BT) stack of the wireless interface adapter 128 in embodiments herein.

As shown, the information handling system 100 may further include a video display device 142. The video display device 142, in an embodiment, may function as a liquid crystal display (LCD), an organic light emitting diode (OLED), a flat panel display, or a solid-state display. Although FIG. 1 shows a single video display device 142, the present specification contemplates that multiple video display devices 142 may be used with the information handling system to facilitate an extended desktop scenario, for example. Additionally, the information handling system 100 may include one or more input/output devices 140 including an alpha numeric input device such as a keyboard 144 and/or a cursor control device, such as a mouse 150, touchpad/trackpad 148, a stylus 146, or a gesture or touch screen input device associated with the video display device 142 that allow a user to interact with the images, windows, and applications presented to the user. In an embodiment, the video display device 142 may provide output to a user that includes, for example, one or more windows describing one or more instances of applications being executed by the hardware processor 102 of the information handling system. In this example embodiment, a window may be presented to the user that provides a graphical user interface (GUI) representing the execution of that application. In an embodiment, the information handling system 100 may include a camera or other presence sensor 166. As described herein, the camera or other presence sensor 166 may be used to detect the presence of the user near the information handling system. In an embodiment, the camera or other presence sensor 166 may include an infrared (IR) sensor, a proximity sensor, a capacitive sensor, a webcam, or a combination thereof and, according to example embodiments herein, are used to detect the presence of a user at any time during operation of the information handling system 100.

The network interface device of the information handling system 100 shown as wireless interface adapter 128 can provide connectivity among devices such as with Bluetooth® or to a network 134, e.g., a wide area network (WAN), a local area network (LAN), wireless local area network (WLAN), a wireless personal area network (WPAN), a wireless wide area network (WWAN), or other network. In an embodiment, the WAN, WWAN, LAN, and WLAN may each include an access point 136 or base station 138 used to operatively couple the information handling system 100 to a network 134. In a specific embodiment, the network 134 may include macro-cellular connections via one or more base stations 138 or a wireless access point 136 (e.g., Wi-Fi or WiGig), or such as through licensed or unlicensed WWAN small cell base stations 138. Connectivity may be via wired or wireless connection. For example, wireless network access points 136 or base stations 138 may be operatively connected to the information handling system 100. Wireless interface adapter 128 may include one or more radio frequency (RF) subsystems (e.g., radio 128) with transmitter/receiver circuitry, modem circuitry, one or more antenna front end circuits 132, one or more wireless controller circuits, amplifiers, antennas 134-1, 134-2 and other circuitry of the radio 128 such as one or more antenna ports used for wireless communications via multiple radio access technologies (RATs). The radio 128 may communicate with one or more wireless technology protocols. In and embodiment, the radio 128 may contain individual subscriber identity module (SIM) profiles for each technology service provider and their available protocols for any operating subscriber-based radio access technologies such as cellular LTE communications.

In an example embodiment, the wireless interface adapter 128, radio 130-1, 130-2, and antenna 134-1, 134-2 may provide connectivity to one or more wireless peripheral devices 156 that may include a wireless video display device 142, a wireless keyboard 144, a wireless mouse 150, a wireless headset, a microphone, a wireless stylus 146, and a wireless trackpad 148, among other wireless peripheral devices used as input/output (I/O) devices 140. The wireless interface adapter 128 may include any number of antennas 134-1, 134-2 which may include any number of tunable antennas for use with the system and methods disclosed herein. In an embodiment, the information handling system 100 includes a Bluetooth® radio operatively coupled to a second antenna 134-2 used operatively couple the wireless peripheral device 156 to the information handling system as described herein.

In some aspects of the present disclosure, the wireless interface adapter 128 may operate two or more wireless links. In embodiments herein, the wireless interface adapter 128 may operate a Bluetooth® wireless link using a Bluetooth® wireless or Bluetooth® Low Energy (BLE). As described herein, the BLE wireless link may be used to communicate with and operatively couple a wireless peripheral device 156 to the information handling system 100. In an embodiment, the Bluetooth® wireless protocol may operate at frequencies between 2.402 to 2.48 GHz. Other Bluetooth® operating frequencies such as Bluetooth® operating frequencies such as 6 GHz are also contemplated in the presented description. In an embodiment, a Bluetooth® wireless link may be used to wirelessly couple the input/output devices operatively and wirelessly including the mouse 150, keyboard 144, stylus 146, trackpad 148, and/or video display device 142 to the bus 116 in order for these devices to operate wirelessly with the information handling system 100.

The wireless interface adapter 128 may operate in accordance with any wireless data communication standards. To communicate with a wireless local area network, standards including IEEE 802.11 WLAN standards (e.g., IEEE 802.11ax-2021 (Wi-Fi 6E, 6 GHZ)), IEEE 802.15 WPAN standards, WWAN such as 3GPP or 3GPP2, Bluetooth® standards, or similar wireless standards may be used. Wireless interface adapter 128 may connect to any combination of macro-cellular wireless connections including 2G, 2.5G, 3G, 4G, 5G or the like from one or more service providers. Utilization of radio frequency communication bands according to several example embodiments of the present disclosure may include bands used with the WLAN standards and WWAN carriers which may operate in both licensed and unlicensed spectrums.

The wireless interface adapter 128 can represent an add-in card, wireless network interface module that is integrated with a main board of the information handling system 100 or integrated with another wireless network interface capability, or any combination thereof. In an embodiment the wireless interface adapter 128 may include one or more radio frequency subsystems including transmitters and wireless controllers for connecting via a multitude of wireless links. In an example embodiment, an information handling system 100 may have an antenna system transmitter for Bluetooth®, BLE, 5G small cell WWAN, or Wi-Fi WLAN connectivity and one or more additional antenna system transmitters for macro-cellular communication. The RF subsystems and radios 130-1, 130-2 and include wireless controllers to manage authentication, connectivity, communications, power levels for transmission, buffering, error correction, baseband processing, and other functions of the wireless interface adapter 128.

During operation, the information handling system 100 may include software and firmware code instructions of a Bluetooth stack associated with the Bluetooth radio 130-2. In an embodiment, this Bluetooth stack may cause the Bluetooth radio 130-2 to monitor for broadcasted advertisements from one or more wireless peripheral devices 156. In an embodiment, the Bluetooth® pairing process includes Bluetooth® Low Energy (BLE) pairing processes that reduces power consumption by the wireless PD 156 and increases the potential pairing with increased diversity of information handling systems 100. Additionally, the BLE pairing systems and process allows for generic attribute profile (GATT) protocols being used that provides various security measures that allows for secure transmission of a copy of the pre-authorization passcode entry information 164-1 from the wireless PD 156 to the information handling system or seed data so the information handling system 100 may generate its own copy of the pre-authorization passcode entry information 164-2 as described herein. As described herein, wireless PDs 156 may include a wireless mouse, a wireless external monitor, a wireless keyboard, a wireless keypad, a wireless, an audio headset/earbud with a microphone, stylus a wireless track pad, and the like. These wireless peripheral devices 156 may be used by the user to interface with the information handling system 100 after the wireless peripheral devices 156 have been paired and operatively coupled, wirelessly, to the information handling system 100 according to the systems and methods described herein. For case of description, the wireless PD 156 is described as being a wireless mouse or a wireless keyboard in some embodiments. However, the present specification contemplates that any type of wireless PD 156 as described herein may use the systems and methods described herein in order to be paired with the information handling system 100.

During monitoring for broadcasts from one or more wireless peripheral devices 156, the wireless interface adapter 128, via the BT radio 130-2, may detect a broadcasted advertisement from the wireless PD 156. In an embodiment, this broadcast signal may be detected as the wireless PD 156 is within a threshold distance from the information handling system 100. In an embodiment, this threshold distance may be between 20 cm to 40 cm. In an embodiment, this threshold distance is 30 cm. This threshold distance may be set so that only close proximity pairing between the information handling system 100 and the wireless PD 156 may be conducted. In an embodiment, the initial broadcast from the wireless PD 156 may include received signal strength indicator (RSSI) data that defines a power level being received by the receiving radio such as the BT antenna 134-2 and BT radio 130-2 after the antenna and possible cable loss. Where the RSSI value is high, the wireless PD 156 is close to the information handling system and where the RSSI value is relatively lower, the wireless PD 156 is further away from the information handling system. In an example embodiment, the Bluetooth stack associated with the BT radio 130-2 may request this RSSI data signal from the wireless PD 156. In an embodiment, therefore, where a wireless peripheral device 186 is activated near multiple information handling systems 100, the RSSI threshold may prevent other information handling systems that are not within a threshold distance of the user's information handling system 100 shown in FIG. 1 for example.

In an embodiment, the broadcasted advertisement from the wireless PD 156 signals to the information handling system 100 to execute, via a hardware processor 102 for example, computer readable program code associated with a pre-authorization security exchange system 162. Similarly, a controller or other processing resource at the wireless PD 156 may execute code instructions of the peripheral device pairing agent 158 to broadcast the advertisement and conduct pre-authorization security exchange and pairing according to embodiments herein. Further, in a parallel operation, the hardware processor 102 for example, may execute program code of a pairing driver to display a pairing graphical user interface (GUI) on the video display device 144. The GUI may indicate to the user that a pairing process has been initiated and the user may select from a plurality of options to either proceed with the pairing process (e.g., “accept” option presented) of reject the pairing process (e.g., “abort” option presented) of the wireless PD 156 to the information handling system 100.

As described herein, the initial broadcast from the wireless PD 156 and which is detected by the information handling system 100 may include a copy of pre-authorization passcode entry information 164-2, or seed data so the information handling system 100 may generate its own copy of the pre-authorization passcode entry information 164-1. In an embodiment, the initial broadcast from the wireless PD 156 and which is detected by the information handling system 100 may include seed data that may be used by the pre-authorization security exchange system 162 and a controller of the wireless PD 156 when executing, for example, a hash function, to generate the pre-authorization passcode entry information 164-1, 164-2. In an embodiment, this pre-authorization passcode entry information 164-1, 164-2 may include a copy of the pre-authorization passcode entry information 164-1 maintained on the information handling system as well as a copy of the pre-authorization passcode entry information 164-2 maintained on the wireless PD 156. This pre-authorization passcode entry information 164-1, 164-2 may be used later to complete authorization for the pairing process of the wireless PD 156 to the information handling system.

In parallel, the pairing GUI is presented to the user on the video display device 144 of the information handling system while the execution of the pre-authorization security exchange system 162 initiates a pre-authorization security exchange process to obtain or generate pre-authorization passcode entry information 164-1. In an embodiment, the pre-authorization passcode entry information 164-1 may be cached in memory prior to the user providing input to the information handling system to either abort or accept the pairing of the wireless PD 156 with the information handling system 100. As described, the wireless PD 156 may also have stored or generated a counterpart pre-authentication passcode information 164-2.

The pre-authorization security exchange communications may begin between the information handling system 100 and the wireless PD 156 to reduce wait time for the pairing process. This is done prior to any pairing acceptance from the user in an embodiment. In order to facilitate the pairing process, the pre-authorization security exchange system 162 of the information handling system 100 also instructs the hardware processor 102, for example, to execute computer readable program code of a user presence detection system 160. The execution of the computer readable program code of the user presence detection system 160 causes the user presence detection system 160 to detect whether the user was or is interacting with the information handling system 100. In an embodiment, the user presence detection system 160 receives data from one or more sensors indicative of user presence within a threshold time limit. In an embodiment, this threshold time limit may be set to two minutes such that where the user presence detection system 160 has detected user presence (e.g., user interaction with the information handling system 100), the user presence detection system 160 indicates user presence to the pre-authorization security exchange system 162.

In an embodiment, the user presence detection system 160 may interact with any type of sensor present within the information handling system 100. These sensors may include any device that detects the presence of the user or detects interactions of the user with the information handling system 100. These sensors include, in an example embodiment, a camera or other presence sensor 166 (e.g., a webcam) capable of detecting an image of the user in front of the information handling system 100. The camera or other presence sensor 166 (e.g., webcam) may be operated by a hardware processing resource (e.g., EC 104) to monitor for a user's presence by, for example, detecting the user's face. In an embodiment, other cameras or sensors 154 may include an infrared (IR) light that may be used in low light conditions to detect the user's face and specifically detect that this specific user had previously interacted with the information handling system 100 within a threshold time limit (e.g., 2 minutes). Where the user's presence has been detected by the webcam, this interaction data is sent to the user presence detection system 160 for the user presence detection system 160 to determine if the user had previously interacted with the information handling system 100 within the threshold time limit.

In an embodiment, the information handling system 100 may include other cameras or sensors 154 such as a motion sensor placed within a housing of the information handling system 100 that detects movement of the information handling system. Movement of the information handling system 100 may indicate that the user is transporting, bumping, or otherwise manipulating the information handling system 100 indicating that the user is interacting with the information handling system 100. Again, this interaction data is sent to the user presence detection system 160 for the user presence detection system 160 to determine if the user had previously interacted with the information handling system 100 within the threshold time limit.

In an embodiment, the information handling system 100 includes a keyboard 146 (e.g., a wired or wireless keyboard) that detects user interaction with the information handling system 100. Because the user provides input to the information handling system 100 by actuating any key on the keyboard 146, this actuation data may also be used by the user presence detection system 160 to determine if the user had previously interacted with the information handling system 100. Again, this interaction data is received by the user presence detection system 160 for the user presence detection system 160 to determine if the user had previously interacted with the information handling system 100 within the threshold time limit. As described herein, other input devices, already operatively coupled to the information handling system 100, such as a wired or wireless mouse 152, a wired or wireless stylus 148, a wired or wireless video display device 144, a wired or wireless trackpad 150 among other input/output device 140. Each of these devices or a set of these devices 140 may be used by the user presence detection system 160 to obtain interaction data that is to be received by the user presence detection system 160 for the user presence detection system 160 to determine if the user had previously interacted with the information handling system 100 within the threshold time limit as described herein.

With the data from these sensors or I/O devices 140 provided to the user presence detection system 160, the user presence detection system 160 may determine if the user has interacted with the information handling system 100 within the threshold time limit. Where the user presence detection system 160 has determined that the user interactions was conducted by the user within the threshold time limit, the user presence detection system 160 may signal to the pre-authorization security exchange system 162 that the information handling system 100 is to have priority to pair with the wireless PD 156. In an embodiment, the pre-authorization security exchange system 162 may signal to the wireless PD 156 that priority is to be given to the information handling system 100 based on the detected user interactions at the information handling system 100 and may commence pre-authorization security exchange communication in preparation to pair with that information handling system 100. Where user presence has not been detected by the user presence detection system 160, other information handling systems may be provided an opportunity to be operatively coupled with the wireless PD 156 and allowed to proceed with the generation and use of the pre-authorization passcode entry information 164-1 at those other information handling systems 100 and at the wireless PD 156 during a delay period.

As described herein, along with the GUI presented to the user to accept or the pairing of the wireless PD 156 to the information handling system 100, pre-authorization passcode entry information 164-1, 164-2 may be generated between the information handling system 100 and the wireless PD 156 in this parallel-executed process. The generation of the pre-authorization passcode entry information 164-1, 164-2 may include the generation of any passcode, hashed passcode, alpha-numeric pairing key, or any other secure data to be used by the information handling system 100 and a counterpart for the wireless PD 156 to securely pair with each other. The generation of the pre-authorization passcode entry information 164-1, 164-2 may be done so as to add an extra layer of security where seed data alone is passed from the wireless PD 156 to the information handling system 100 in BLE pairing advertisement communication without an actual pre-authorization passcode entry information 164-1, 164-2 being transmitted in some embodiments. However, the present specification contemplates that the pre-authorization passcode entry information 164-1 may be passed to the information handling system 100 and a copy maintained on the wireless PD 156 for later use in other embodiments.

While the information handling system 100 is awaiting user input indicating whether to pair (“accept”) the wireless PD 156 with the information handling system 100 or not (“abort”), this pre-authorization passcode entry information 164-1, 164-2 may be generated and saved or cached by the pre-authorization security exchange system 162. In an embodiment, the pre-authorization passcode entry information 164-1, 164-2 may be saved on a secure memory device such as a unified extensible firmware interface (UEFI) memory device. It is appreciated that any safe data storage device or other memory device (e.g., main memory 106, static memory 108, etc.) may be used to temporarily store the pre-authorization passcode entry information 164-1, 164-2 prior to the user providing input to accept the pairing of the information handling system 100 to the wireless PD 156. In some embodiments, exchange communication for verification of this pre-authorization passcode entry information 164-1, 164-2 by the pre-authorization security exchange system 162 may commence as well to allow for parallel operation without any wait for user acceptance and to speed the pairing process.

In an embodiment, the pre-authorization passcode entry information 164 may be calculated by either or both of the wireless PD 156 and information handling system 100 in preparation of pairing the information handling system 100 to the wireless PD 156. Multiple sets of pre-authorization passcode entry information 164-1 may be saved by the information handling system 100 when multiple wireless PDs 156 have initiated the pairing process and have broadcasted a pairing request signal with its advertising packets. In an embodiment, as a new pairing advertisement packet broadcast is detected by the BT stack of the BT radio 130-2, the pre-authorization security exchange system 162 may first determine whether pre-authorization passcode entry information 164-1 has already or been generated by the information handling system 100 for this wireless PD 156. Where this pre-authorization passcode entry information 164-1 is detected in the cache or other storage, the process of receiving and/or generating the pre-authorization passcode entry information 164-1 may be skipped and, in some embodiments, authorization commenced while confirmation of pairing from the user may be anticipated.

By calculating the pre-authorization passcode entry information 164-1 prior to the user accepting the pairing process, the information handling system 100 may increase the speed at which the wireless PDs 156 paired to the information handling system 100 by pre-emptively making these calculations (e.g., generation of hash keys, passcodes, and other pairing verification data) in anticipation for pairing at a later time. Indeed, even where the user may abort the pairing process by, for example, selecting the abort option on the GUI, this pre-authorization passcode entry information 164-1 may be stored until if and when the wireless PD 156 broadcast is again detected by the BT radio 130-2. It is appreciated that although a user may select the abort option on the GUI, a user may also delay acceptance. Thus, with no response from a user, the storage or caching of the pre-authorization passcode entry information 164-1 allows for relatively quicker pairing when the pairing process is reset and tried again after a timeout by the wireless PD 156. The systems and methods described herein, therefore, overcomes the blocking or sequential pairing requirements typically used during the pairing process and instead allows for certain processes such as the calculation or development of the pre-authorization passcode entry information 164-1 prior to other processes such as the requirement of acceptance or aborting of the pairing process by the user.

Additionally, some information handling systems 100 include automatic pairing services systems and associated computer readable program code that, when executed by a hardware processor, initiates an automatically pairing process between the information handling system 100 and wireless PD 156 even where the information handling system 100 may not include an input/output device 140. An example of such automatic pairing services systems includes Dell® Pair Service used to automate passcode entry process for Dell® information handling systems 100 which requires the pre-authorization custom security credential exchange (Pre-CSEXG) step. This Pre-CSEXG step requires around an additional 4 to 6 seconds to complete and is completed after the user accepts the pairing process to proceed, or in some embodiments begins while the user acceptance of the pairing is pending. Pairing itself may not commence until acceptance and issuance of a pairing request after authorization in some embodiments. The systems and methods described herein, allow for the generation of this Pre-CSEXG data in the form of the pre-authorization passcode entry information 164-1 prior to any input from the user including acceptance of the pairing process between the information handling system 100 and wireless PD 156. By doing so, the user may see a more streamlined pairing once the user has accepted.

In an embodiment where the user presence detection system 160 has not detected user presence within the threshold time limit, the pre-authorization passcode entry information 164 may be generated and stored by the information handling system 100. Additionally, in an example embodiment, the wireless PD 156 may be allowed to be paired with other information handling systems, if any, that are within range in order to engage in the exchange of the pre-authorization passcode entry information 164-1 as described herein. Where user presence has been detected within the threshold time limit, however, the information handling system 100 may be given pairing priority and the pre-authorization security exchange system 162 may wait for user acceptance of the pairing processes described herein or may in an embodiment begin while user acceptance is pending in other embodiments. Only when the wireless PD 156 subsequently broadcasts the advertisement package again, after the user fails to accept the pairing, the pre-authorization security exchange system 162 will access the stored pre-authorization passcode entry information 164-1 for authorization of pairing. Thus, the pre-authorization passcode entry information 164-1 may be stored in those situations where user input is not received due to a timeout and used with a new advertisement package caused by wireless PD 156 in a retry.

Where the user accepts the pairing process, the pre-authorization passcode entry information 164 is generated, in parallel to the GUI display, and then is used to issue a pairing request to operatively pair the wireless PD 156 to the information handling system 100 with a session key under BT protocols. Therefore, the process may cause the exchange of the pre-authorization passcode entry information 164 between the wireless PD 156 and the information handling system 100. Again, to some extent the timing of when the user selects the “accept” option on the GUI may determine how much the parallel generated pre-authorization passcode entry information 164-1, 164-2 has reduced the time used to complete the pairing of the wireless PD 156 to the information handling system 100 as perceived by the user. This pairing process may continue pursuant to the operating Bluetooth® pairing protocols such as the BLE protocol described herein.

In an example embodiment, as part of the BLE protocol, the information handling system 100 may generate, with a value generator function, and encrypted Mconfirm value via an encryption algorithm that may serve as pre-authorization passcode entry information 164-1. This Mconfirm value may be provided to the wireless PD 156. The Mconfirm value may be decrypted at the wireless PD 156. Further, the wireless PD 156 may generate an Sconfirm value that may also be similarly generated with a value generator function and then encrypted at the wireless PD 156. The Sconfirm value that may serve as a pre-authorization passcode entry information 164-2 may be sent to the information handling system 100 for decryption to determine the sent Sconfirm value. A match of the received Sconfirm from the wireless PD 156 with the Mconfirm from the information handling system 100 may be used as verification in such an example embodiment. Where the values match, the BT pairing process may issue a pairing request upon acceptance of the pairing by a user and establishes a session key and a BT wireless link via the OS BT stack and BT protocols. Then the BT pairing process is completed between wireless PD 156 and information handling system 100. Although the present specification describes specific pairing processes being used after the user has provided input to accept the pairing of the wireless PD 156 to the information handling system 100, the present specification contemplates that other and/or additional processes may be used to complete the pairing process as described herein.

In an embodiment, the information handling system 100 can include one or more sets of machine-readable code instructions, parameters, and profiles 112 that can be executed to cause the computer system to perform any one or more of the methods or computer-based functions disclosed herein. For example, machine-readable code instructions, parameters, and profiles 112 may execute, via hardware processing resources, various software applications, software agents, the BIOS 114 firmware and/or software, or other aspects or components. Machine-readable code instructions, parameters, and profiles 112 may execute, via the information handling system 100, the pre-authorization security exchange system 162, the user presence detection system 160 which controls the generation of pre-authorization passcode entry information 164 and pairing of the wireless PD 156 to the information handling system 100 for verification and pairing with the wireless PD 156. Again, the machine-readable code instructions, parameters, and profiles 112 described herein may be stored on a non-volatile memory device and made accessible to the EC 104, the hardware processor 104, a microcontroller unit (MCU), or other hardware processing resource for execution. Various software modules comprising application instructions of machine-readable code instructions, parameters, and profiles 112 may be coordinated by an operating system (OS) 116, and/or via an application programming interface (API). An example OS 116 may include Windows®, Android®, and other OS types known in the art. Example APIs may include Win 32, Core Java API, or Android APIs.

In an embodiment, the disk drive unit 120 and may include machine-readable code instructions, parameters, and profiles 112 in which one or more sets of machine-readable code instructions, parameters, and profiles 112 such as software can be embedded to be executed by the processor 102 or other hardware processing devices such as a GPU 154 to perform the processes described herein. Similarly, main memory 106 and static memory 108 may also contain a computer-readable medium for storage of one or more sets of machine-readable code instructions, parameters, or profiles 112 described herein. The disk drive unit 120 or static memory 108 also contain space for data storage. Further, the machine-readable code instructions, parameters, and profiles 112 may embody one or more of the methods as described herein. In a particular embodiment, the machine-readable code instructions, parameters, and profiles 112 may reside completely, or at least partially, within the main memory 106, the static memory 108, and/or within the disk drive 120 during execution by the hardware processor 102, EC 104, or GPU 154 of information handling system 100. The main memory 106, GPU 154, EC 104, and the hardware processor 102 also may include computer-readable media.

Main memory 106 or other memory of the embodiments described herein may contain computer-readable medium (not shown), such as RAM in an example embodiment. An example of main memory 106 includes random access memory (RAM) such as static RAM (SRAM), dynamic RAM (DRAM), non-volatile RAM (NV-RAM), or the like, read only memory (ROM), another type of memory, or a combination thereof. Static memory 108 may contain computer-readable medium (not shown), such as NOR or NAND flash memory in some example embodiments. The applications and associated APIs, for example, may be stored in static memory 108 or on the disk drive unit 120 that may include access to a machine-readable code instructions, parameters, and profiles 112 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 and/or the backend management server 170 may further include a power management unit (PMU) 122 (a.k.a. a power supply unit (PSU)). The PMU 122 may include a hardware controller and executable machine-readable code instructions to manage the power provided to the components of the information handling system 100 such as the hardware processor 102, and other hardware components described herein. The PMU 122 may control power to one or more components including the one or more drive units 120, the hardware processor 102 (e.g., CPU), the EC 104, the GPU 154, a video/graphic display device 144 or other wired input/output devices 140 such as the stylus 148, a mouse 152, a keyboard 146, and a trackpad 150 and other components that may require power when a power button has been actuated by a user. In an embodiment, the PMU 122 may monitor power levels and be electrically coupled, either wired or wirelessly, to the information handling system 100 and/or the backend management server 170 to provide this power and coupled to bus 118 to provide or receive data or machine-readable code instructions. The PMU 122 may regulate power from a power source such as a battery 124 or AC power adapter 126. In an embodiment, the battery 124 may be charged via the AC power adapter 126 and provide power to the components of the information handling system 100, via a wired connections as applicable, or when AC power from the AC power adapter 126 is removed. PMU 122 may include a hardware controller to operate with the EC 104 separately or together to execute machine-readable code instructions, parameters, and profiles 112 of the pre-authorization security exchange system 162 and/or user presence detection system 160 at the information handling system 100.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device.” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, ARM® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

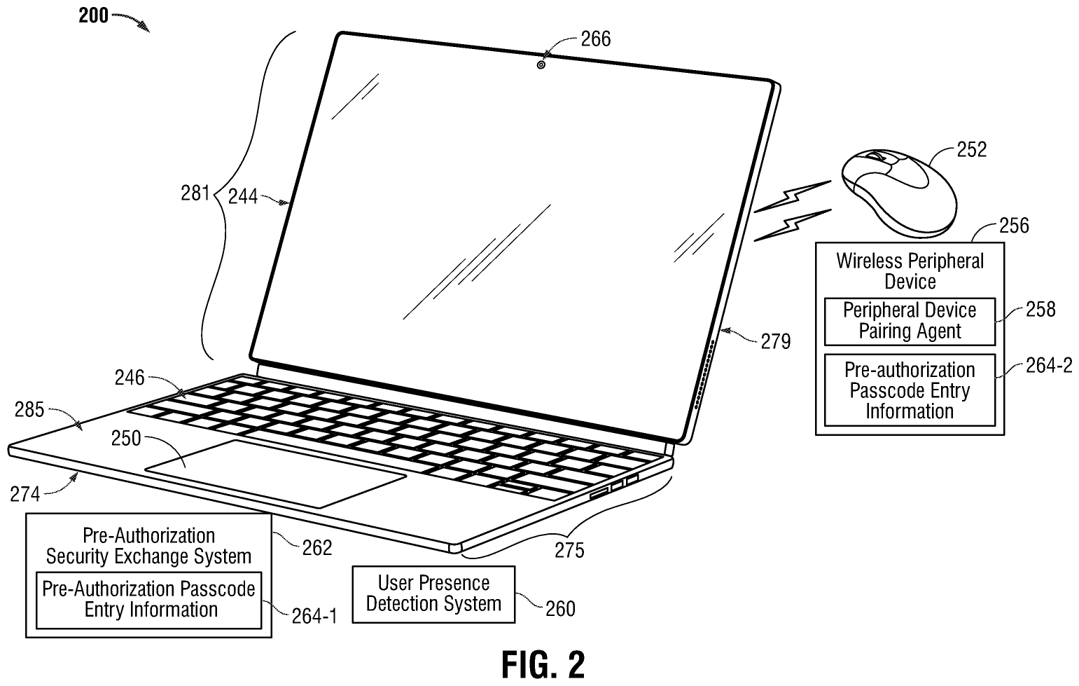

FIG. 2 is a graphic diagram of an information handling system 200 pairable with a wireless peripheral device 256 using a pre-authorization security exchange system 262 according to an embodiment of the present disclosure. It is appreciated that any type of wireless PD 256 may be wirelessly coupled to the information handling system 200 and may include any wireless input/output device shown in FIG. 1 such as a wireless video display device (e.g., external video display device), a wireless stylus, a wireless trackpad, and other similar devices.

The information handling system 200 may, in an example embodiment, be a laptop-type information handling system 200. The information handling system 200 may, in an example embodiment, be a 360°-type information handling system 200. In the example shown in FIG. 2, the information handling system 200 may be a 360° information handling system 200 where an exterior surface of the bottom cover or bottom chassis 274 of a base chassis 275 may be brought towards an exterior side of the back display chassis 279 of the display chassis 281 to place the information handling system 200 in a tablet configuration in one embodiment. As shown in FIG. 2, the information handling system 200 may also be placed in a laptop configuration where the base chassis 275 is lying flat on a surface with the display chassis 281 being placed upright from the base chassis 275. Other configurations such as a dual tablet configuration and a tent orientation are contemplated as described herein.

The information handling system 200 may include a plurality of chassis made of metal, plastic, or the like. The information handling system 200, in an embodiment, may comprise an outer case or shell of an information handling system 200 for housing internal components of the information handling system 200, such as a video display device 244 (e.g., a built-in video display device 244), a cursor control device (e.g., built-in trackpad or touchpad 250), and an alpha numeric input device (e.g., built-in keyboard 291). As shown in FIG. 2, the information handling system 200 may include a built-in video display device 244 functioning to enclose the display chassis 281 with the back display chassis 279 described herein. In an embodiment, the information handling system 200 may include a camera or other presence sensor 266. As described herein, the camera or other presence sensor 266 may be used to detect the presence of the user near the information handling system. In an embodiment, the camera or other presence sensor 266 may include an infrared (IR) sensor, a proximity sensor, a capacitive sensor, a webcam, or a combination thereof and, according to example embodiments herein, are used to detect the presence of a user at any time during operation of the information handling system 200.

As another example, the information handling system 200 may further include the keyboard chassis 285 functioning to enclose a cursor control device such as a trackpad 250 and/or the built-in keyboard 291 acting as an alpha numeric input device. The back display chassis 279 and the video display device 244 may be joined together in an embodiment to form a fully enclosed display chassis 281, while the keyboard chassis 285 and a bottom chassis 274 may be joined together to form a fully enclosed base chassis 275. Taking a closed configuration as a reference position of the video display device 244 including the back display chassis 279 and the base chassis 275 including the keyboard chassis 285 and bottom chassis 274, the video display device 244 and back display chassis 279 may be rotated away from the base chassis 275 into the laptop configuration as shown in FIG. 2.

During operation, the information handling system 200 may include software and firmware code instructions of a Bluetooth stack associated with the Bluetooth radio (not shown). In an embodiment, this Bluetooth stack may cause the Bluetooth radio to monitor for broadcasted advertisements from one or more wireless peripheral devices 256. In an embodiment, the Bluetooth® pairing process includes Bluetooth® Low Energy (BLE) pairing processes that reduces power consumption by the wireless PD 256 and increases the potential pairing with increased diversity of information handling systems 200. Additionally, the BLE pairing systems and process allows for generic attribute profile (GATT) protocols being used that provides various security measures that allows for secure transmission of data messages including transmission of the pre-authorization passcode entry information 264-1 from the wireless PD 256 to the information handling system in an BT pairing advertising packet described herein. As described herein, wireless PDs 256 may include a wireless mouse, a wireless external monitor, a wireless keyboard, a wireless keypad, a wireless stylus a wireless track pad, and the like. These wireless peripheral devices 256 may be used by the user to interface with the information handling system 200 after the wireless peripheral devices 256 have been paired and operatively coupled, wirelessly, to the information handling system 200 according to the systems and methods described herein. For case of description, the wireless PD 256 is described as being a wireless mouse in some embodiments. However, the present specification contemplates that any type of wireless PD 256 as described herein may use the systems and methods described herein in order to be paired with the information handling system 200.

During monitoring for broadcasts from one or more wireless peripheral devices 256, the wireless interface adapter 228, via the BT radio, may detect a broadcasted advertisement from the wireless PD 256. In an embodiment, this broadcast signal may be detected as the wireless PD 256 is within a threshold distance from the information handling system 200 or at a received signal strength indicator (RSSI) level indicating sufficient proximity. In an embodiment, this threshold distance may be between 20 cm to 40 cm. In an embodiment, this threshold distance is set at 30 cm. This threshold distance may be set so that only close proximity pairing between the information handling system 200 and the wireless PD 256 may be conducted. In an embodiment, the initial broadcast from the wireless PD 256 may include received signal strength indicator (RSSI) data that defines a power level being received by the receiving radio such as the BT antenna (not shown) and BT radio after the antenna and possible cable loss. Where the RSSI value is high, the wireless PD 256 is close to the information handling system and where the RSSI value is relatively lower, the wireless PD 256 is further away from the information handling system. In an example embodiment, the Bluetooth stack associated with the BT radio may request this RSSI data signal from the wireless PD 256. In an embodiment, therefore, where a wireless peripheral device 286 is activated near multiple information handling systems 200, the RSSI threshold may prevent other information handling systems that are not within a threshold distance of the user's information handling system 200 shown in FIG. 2 for example.

In an embodiment, the broadcasted advertisement from the wireless PD 256 signals to the information handling system 200 to execute, via a hardware processor for example, computer readable program code associated with a pre-authorization security exchange system 262. Similarly, a controller or other processing resource at the wireless PD 256 may execute code instructions of the peripheral device pairing agent 258 to broadcast the advertisement and conduct pre-authorization security exchange and pairing according to embodiments herein. Further, in a parallel operation, the hardware processor for example, may execute program code of a pairing driver to display a pairing graphical user interface (GUI) on the video display device 244. The GUI may indicate to the user that a pairing process has been initiated and the user may select from a plurality of options to either proceed with the pairing process (e.g., “accept” option presented) of reject the pairing process (e.g., “abort” option presented) of the wireless PD 256 to the information handling system 200.

As described herein, the initial broadcast from the wireless PD 256 and which is detected by the information handling system 200 may include pre-authorization passcode entry information 264-1, 264-2. In an embodiment, the initial broadcast from the wireless PD 256 and which is detected by the information handling system 200 may include seed data that may be used by the pre-authorization security exchange system 262 and a processor or controller at the information handling system 200 and a controller of the wireless PD 256 when executing, for example, a hash function, to similarly generate the respective pre-authorization passcode entry information 264-1, 264-2. In an embodiment, this pre-authorization passcode entry information 264-1, 264-2 may include a copy of the pre-authorization passcode entry information 264-1 maintained on the information handling system as well as a copy of the pre-authorization passcode entry information 264-2 maintained on the wireless PD 256. This pre-authorization passcode entry information 264-1, 264-2 may be used later to authorize pairing with a pre-authorization pass code security exchange communication and then complete the pairing process of the wireless PD 256 to the information handling system.

In parallel, the pairing GUI is presented to the user on the video display device 244 of the information handling system while the execution of the pre-authorization security exchange system 262 initiates a pre-authorization security exchange process to obtain or generate pre-authorization passcode entry information 264-1. In an embodiment, the pre-authorization passcode entry information 264-1 may be cached in memory prior to the user providing input to the information handling system to either abort or accept the pairing of the wireless PD 256 with the information handling system 200. As described, the wireless PD 256 may also have stored or generated a counterpart pre-authentication passcode information 264-2.

The pre-authorization security exchange communications may begin between the information handling system 200 and the wireless PD 256 to reduce wait time for the pairing process. This is done prior to any pairing acceptance from the user in an embodiment. In order to facilitate the pairing process, the pre-authorization security exchange system 262 of the information handling system 200 also instructs the hardware processor 202, for example, to execute computer readable program code of a user presence detection system 260. The execution of the computer readable program code of the user presence detection system 260 causes the user presence detection system 260 to detect whether the user was or is interacting with the information handling system 200. In an embodiment, the user presence detection system 260 receives data from one or more sensors indicative of user presence within a threshold time limit. In an embodiment, this threshold time limit may be set to two minutes such that where the user presence detection system 260 has detected user presence (e.g., user interaction with the information handling system 200), the user presence detection system 260 indicates user presence to the pre-authorization security exchange system 262.

In an embodiment, the user presence detection system 260 may interact with any type of sensor present within the information handling system 200. These sensors may include any device that detects the presence of the user or detects interactions of the user with the information handling system 200. These sensors include, in an example embodiment, a camera or other presence sensor 266 (e.g., a webcam) capable of detecting an image of the user in front of the information handling system 200. The camera or other presence sensor 266 (e.g., webcam) may be operated by a hardware processing resource (e.g., EC) to monitor for a user's presence by, for example, detecting the user's face. In an embodiment, other cameras or sensors 254 may include an infrared (IR) light that may be used in low light conditions to detect the user's face and specifically detect that this specific user had previously interacted with the information handling system 200 within a threshold time limit (e.g., 2 minutes). Presence may also be detected by a user using other peripheral devices, such as keyboard 246, touchpad 250, or screen 244, that are already active with the information handling system within the threshold historical time period before the BT pairing advertisement request is received. Where the user's presence has been detected by the webcam or other interaction, this interaction data is sent to the user presence detection system 260 for the user presence detection system 260 to determine if the user had previously interacted with the information handling system 200 within the threshold time limit.

In an embodiment, the information handling system 200 may include other cameras or sensors 254 such as a motion sensor placed within a housing of the information handling system 200 that detects movement of the information handling system. Movement of the information handling system 200 may indicate that the user is transporting, bumping, or otherwise manipulating the information handling system 200 indicating that the user is interacting with the information handling system 200. Again, this interaction data is sent to the user presence detection system 260 for the user presence detection system 260 to determine if the user had previously interacted with the information handling system 200 within the historical threshold time limit prior to the BT pairing advertisement being received.

In an embodiment, the information handling system 200 includes a keyboard 246 (e.g., a wired or wireless keyboard) that detects user interaction with the information handling system 200. Because the user provides input to the information handling system 200 by actuating any key on the keyboard 246, this actuation data may also be used by the user presence detection system 260 to determine if the user had previously interacted with the information handling system 200. Again, this interaction data is received by the user presence detection system 260 for the user presence detection system 260 to determine if the user had previously interacted with the information handling system 200 within the historical threshold time limit prior to the BT pairing advertisement being received. As described herein, other input devices, already operatively coupled to the information handling system 200, such as a wired or wireless mouse 252, a wired or wireless stylus 248, a wired or wireless video display device 244, a wired or wireless trackpad 250 among other input/output device 240. Each of these devices or a set of these devices 240 may be used by the user presence detection system 260 to obtain interaction data that is to be received by the user presence detection system 260 for the user presence detection system 260 to determine if the user had previously interacted with the information handling system 200 within the threshold time limit as described herein.

With the data from these sensors or I/O devices 240 provided to the user presence detection system 260, the user presence detection system 260 may determine if the user has interacted with the information handling system 200 within the historical threshold time limit before BT pairing advertisement is received. Where the user presence detection system 260 has determined that the user interactions was conducted by the user within the threshold time limit, the user presence detection system 260 may signal to the pre-authorization security exchange system 262 that the information handling system 200 is to have priority to pair with the wireless PD 256. In an embodiment, the pre-authorization security exchange system 262 may signal to the wireless PD 256 that priority is to be given to the information handling system 200 based on the detected user interactions at the information handling system 200 and may commence pre-authorization security exchange communication in preparation to pair with that information handling system 200. No delay in such an instance is provided for to allow for other information handling systems to pair with the BT wireless PD 256 when priority is determined due to recency of user presence interaction. Where user presence has not been detected by the user presence detection system 260, other information handling systems may be provided an opportunity to be operatively coupled with the wireless PD 256 and allowed to proceed with the generation and use of the pre-authorization passcode entry information 264-1 at the information handling system 200 and at the wireless PD 256.

As described herein, along with the GUI presented to the user to accept or the pairing of the wireless PD 256 to the information handling system 200, pre-authorization passcode entry information 264-1, 264-2 may be generated between the information handling system 200 and the wireless PD 256 in this parallel-executed process. The generation of the pre-authorization passcode entry information 264-1, 264-2 may include the generation of any passcode, hashed passcode, alpha-numeric pairing key, or any other secure data to be used by the information handling system 200 and a counterpart for the wireless PD 256 to securely pair with each other. The generation of the pre-authorization passcode entry information 264-1, 264-2 may be done so as to add an extra layer of security where seed data alone is passed from the wireless PD 256 to the information handling system 200 without an actual pre-authorization passcode entry information 264-1, 264-2 being transmitted. However, the present specification contemplates that the pre-authorization passcode entry information 264-1 may be passed to the information handling system 200 and a copy maintained on the wireless PD 256 for later use.

While the information handling system 200 is awaiting user input indicating whether to pair (“accept”) the wireless PD 256 with the information handling system 200 or not (“abort”), this pre-authorization passcode entry information 264-1, 264-2 may be generated and saved or cached by the pre-authorization security exchange system 262. In an embodiment, the pre-authorization passcode entry information 264-1, 264-2 may be saved on a secure memory device such as a unified extensible firmware interface (UEFI) memory device. It is appreciated that any safe data storage device or other memory device (e.g., main memory, static memory, etc.) may be used to temporarily store the pre-authorization passcode entry information 264-1, 264-2 prior to the user providing input to accept the pairing of the information handling system 200 to the wireless PD 256. In some embodiments, exchange communication for verification of this pre-authorization passcode entry information 264-1, 264-2 by the pre-authorization security exchange system 262 may commence as well.

In an embodiment, the pre-authorization passcode entry information 264-1, 264-2 may be calculated by either or both of the wireless PD 256 and information handling system 200 in preparation of pairing the information handling system 200 to the wireless PD 256. Multiple sets of pre-authorization passcode entry information 264-1 may be saved by the information handling system 200 when multiple wireless PDs 256 have initiated the pairing process and have broadcasted a pairing request signal with its advertising packets. In an embodiment, as a new packet broadcast is detected by the BT stack of the BT radio, the pre-authorization security exchange system 262 may first determine whether pre-authorization passcode entry information 264-1 has already or been generated by the information handling system 200 for this wireless PD 256. Where this pre-authorization passcode entry information 264-1 is detected in the cache or other storage, the process of receiving and/or generating the pre-authorization passcode entry information 264-1 may be skipped and authorization with pre-authorization security exchange communication may occur while confirmation of pairing from the user is anticipated.

By calculating the pre-authorization passcode entry information 264-1 prior to the user accepting the pairing process, the information handling system 200 may increase the speed at which the wireless PDs 156 paired to the information handling system 100 by pre-emptively making these calculations (e.g., generation of hash keys, passcodes, and other pairing verification data) in anticipation for pairing at a later time. Indeed, even where the user may abort the pairing process by, for example, selecting the abort option on the GUI, this pre-authorization passcode entry information 164-2 may be stored until if and when the wireless PD 156 broadcast is again detected by the BT radio 230-2. It is appreciated that although a user may select the abort option on the GUI, a user may also delay acceptance. Thus, with no response from a user, the storage or caching of the pre-authorization passcode entry information 264-1 allows for relatively quicker pairing when the pairing process is reset and tried again after a timeout by the wireless PD 256. The systems and methods described herein, therefore, overcomes the blocking or sequential pairing requirements typically used during the pairing process and instead allows for certain processes such as the calculation or development of the pre-authorization passcode entry information 264-1 prior to other processes such as the requirement of acceptance or aborting of the pairing process by the user.

Additionally, some information handling systems 200 include automatic pairing services systems and associated computer readable program code that, when executed by a hardware processor, initiates an automatically pairing process between the information handling system 200 and wireless PD 256 even where the information handling system 200 may not include an input/output device 240. An example of such automatic pairing services systems includes Dell® Pair Service used to automate passcode entry process for Dell® information handling systems 200 which requires the pre-authorization custom security credential exchange (Pre-CSEXG) step. This Pre-CSEXG step requires around an additional 4 to 6 seconds to complete and is only completed after the user accepts the pairing process to proceed. The systems and methods described herein, allow for the generation of this Pre-CSEXG data in the form of the pre-authorization passcode entry information 264-1, and may allow for pre-authorization security exchange communication to begin in some embodiments, prior to any input from the user including acceptance of the pairing process between the information handling system 200 and wireless PD 256. By doing so, the user may see a more streamlined pairing once the user has accepted.

In an embodiment where the user presence detection system 260 has not detected user presence within the threshold time limit, the pre-authorization passcode entry information 264 may be generated and stored by the information handling system 200. Additionally, in an example embodiment, the wireless PD 256 may be allowed to be paired with other information handling systems, if any, that are within range in order to engage in the exchange of the pre-authorization passcode entry information 264-1 as described herein. Where user presence has been detected within the threshold time limit, however, the information handling system 200 may be given pairing priority and the pre-authorization security exchange system 262 may conduct pre-authorization security exchange communications while waiting for user acceptance of the pairing processes described herein. Pairing will not commence until acceptance by the user and a pairing request is issued. Only when the wireless PD 256 subsequently broadcasts the advertisement package again after the user fails to accept the pairing, the pre-authorization security exchange system 262 will access the pre-authorization passcode entry information 264-1 for pairing. Thus, the pre-authorization passcode entry information 264-1 may be stored in those situations where user input is not received due to a timeout and used with a new advertisement package caused by wireless PD 256 in a retry.

Where the user accepts the pairing process, the pre-authorization passcode entry information 264 is generated, in parallel to the GUI display, and then is used to issue a pairing request to operatively pair the wireless PD 256 to the information handling system 200 with a session key under BT protocols after authorization has occurred. Therefore, the process may cause the exchange of the pre-authorization passcode entry information 264 between the wireless PD 256 and the information handling system 200. Again, to some extent the timing of when the user selects the “accept” option on the GUI may determine how much the parallel generated pre-authorization passcode entry information 264-1, 264-2 has reduced the time used to complete the pairing of the wireless PD 256 to the information handling system 200 as perceived by the user. This pairing process may continue pursuant to the operating Bluetooth® pairing protocols such as the BLE protocol described herein.

In an example embodiment, as part of the BLE protocol, the information handling system 200 may generate, with a value generator function, and encrypted Mconfirm value via an encryption algorithm that may serve as pre-authorization passcode entry information 264-1 or a representation of the same for exchange. This Mconfirm value may be provided to the wireless PD 256. The Mconfirm value may be decrypted at the wireless PD 256. Further, the wireless PD 256 may generate an Sconfirm value that may also be similarly generated with a value generator function and then encrypted at the wireless PD 256. The Sconfirm value that may serve as a pre-authorization passcode entry information 264-2 may be sent to the information handling system 200 for decryption to determine the sent Sconfirm value. A match of the received Sconfirm from the wireless PD 256 with the Mconfirm from the information handling system 200 may be used as verification in such an example embodiment.

Where the values match or where the pre-authorization passcode entry information 264-1 at the information handling system 200 and 264-2 at the wireless PD 256 match, the BT pairing process may issue a pairing request upon acceptance of the pairing by a user to allow pairing to proceed. Upon user acceptance of pairing, execution of the BT pairing protocol establishes a session key and a BT wireless link via the OS BT stack and BT protocols at the BT wireless radios and radio controllers. Then the BT pairing process is completed between wireless PD 256 and information handling system 200. Although the present specification describes specific pairing processes being used after the user has provided input to accept the pairing of the wireless PD 256 to the information handling system 200, the present specification contemplates that other and/or additional processes may be used to complete the pairing process as described herein.

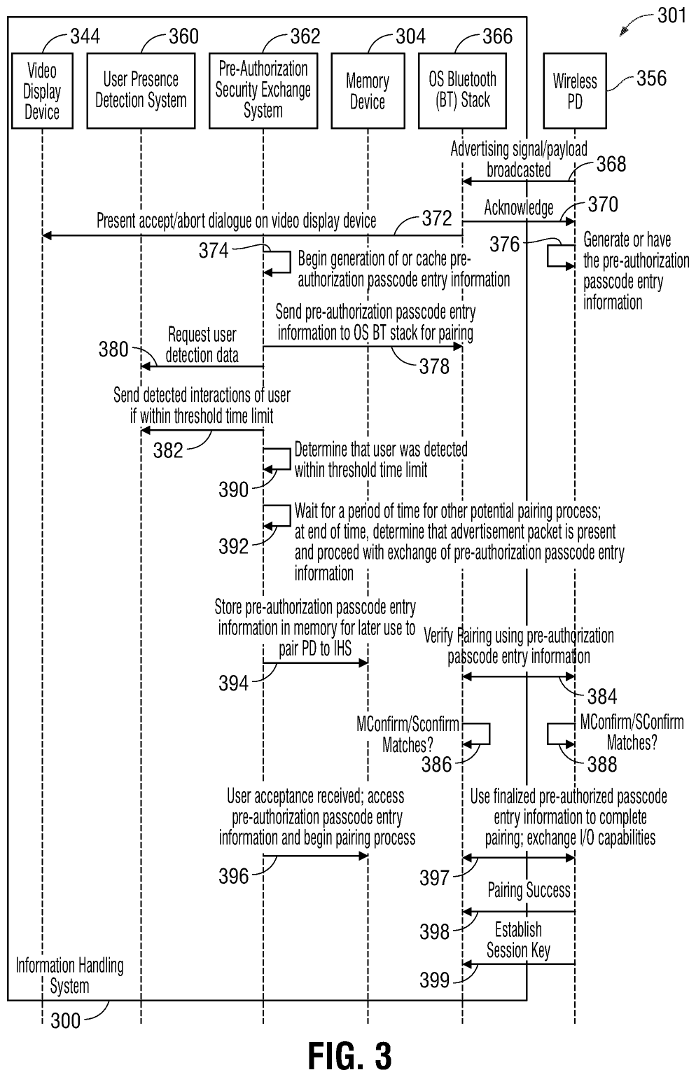

FIG. 3 is a process flow diagram of a method 301 of querying, verifying, and Bluetooth® pairing a wireless peripheral device 356 to an information handling system 300 using the pre-authorization security exchange system 362 according to an embodiment of the present disclosure. As described herein, a wireless PD 356 may be activated by a user so that the pairing processes described herein may be initiated. As described herein, the information handling system 300 includes a video display device 344, a user presence detection system 360, a pre-authorization security exchange system 362, a memory device 304, and an operating system (OS) Bluetooth® stack 366.

During operation and when the user has turned on the wireless PD 356 or otherwise activated the wireless PD 356, the wireless PD 356 may broadcast, at line 368, a pairing advertisement to the information handling system 200 or any information handling system within range of the wireless PD 356. In an embodiment, this broadcasting at line 368 may include other data described as a “payload” available, for example, under the BLE protocol with BT wireless pairing advertisements. This payload data may include a variety of initiating data that may include received signal strength indicator (RSSI) data that allows the radio to determine a power level being received by the receiving radio such as the BT antenna and BT radio on the information handling system 300 after the antenna and possible cable loss. The payload data may also include identification data describing the wireless PD 356 which may include manufacturing data, the type of wireless PD 356, and the capabilities of the wireless PD 356, among other broadcasting data. The broadcasting of this data is received by the BT radio and provided to the OS Bluetooth® stack 366 at line 368. Additionally, the payload includes pre-authorization passcode entry information in an embodiment. In another embodiment, the payload may include seed data describing how, at the information handling system 300, the pre-authorization security exchange system 362 can derive the pre-authorization passcode entry information as described herein. In those embodiments where seed data is received instead of the pre-authorization passcode entry information, the payload data may include a selection of a hash function and/or a random number or random number generator used by the information handling system 300 and wireless PD 356 to generate their respective, matching, pre-authorization passcode entry information.

At line 370, the information handling system 300 may send an acknowledgment to the wireless PD 356. This acknowledgement may include an indication to the wireless PD 356 that the information handling system 300 has responded to the broadcast of the wireless PD 356, has received the payload data (e.g., pre-authorization passcode entry information or seed data) and, in an embodiment, provided the address of the information handling system 300.

At line 372 the OS Bluetooth® stack 366 may instruct the video display device 344 to present a GUI to the user requesting the user to accept or abort the pairing of the wireless PD 356 to the information handling system 300 as described herein. The user may, in an embodiment, be present to either accept or abort the pairing. In another embodiment where the user is not immediately present to either accept or abort the pairing, the pre-authorization security exchange system 362 described herein may conduct the parallel computations and generation of the pre-authorization passcode entry information used later to pair the wireless PD 356 to the information handling system 300.

At line 374, the pre-authorization security exchange system 362 may begin to generate or cache the pre-authorization passcode entry information. Again, where the payload from the wireless PD 156 includes the pre-authorization passcode entry information, this pre-authorization passcode entry information may simply be cached for later user. However, where the payload included seed data (e.g., hash function and/or a random number or random number generator), a hardware processing device (e.g., CPU, GPU, EC, etc.) may execute the hash function and/or a random number or random number generator to generate the pre-authorization passcode entry information and then cache that derived pre-authorization passcode entry information in a secure memory storage device.

At this point, at line 378, the pre-authorization security exchange system 362 sends the pre-authorization passcode entry information to the OS BT stack 366 for the OS BT stack 366 to engage in a preliminary exchange of the pre-authorization passcode entry information with the wireless PD 356. In an embodiment, this pairing process may include, at line 384 the pre-authorization security exchange communications for verification of the pairing of the wireless PD 356 with the information handling system 300 using the pre-authorization passcode entry information. In one example embodiment, as part of the BLE protocol, the information handling system 300 may generate, with a value generator function, and encrypted Mconfirm value via an encryption algorithm. This Mconfirm value may be provided to the wireless PD 356. The Mconfirm value may be decrypted at the wireless PD 356. Further, the wireless PD 356 may generate an Sconfirm value that may also be similarly generated with a value generator function and then encrypted at the wireless PD 356. The Sconfirm value may be sent to the information handling system 100 for decryption to determine the sent Sconfirm value. The exchange of the Mconfim and Sconfirm values at lines 386 and 388 may not necessarily be exactly the same exchange process as that detailed in the Bluetooth® LE protocols. Instead, in an embodiment, the exchange of Mconfirm and Sconfirm values may be part of a custom pre-authorization process with an encrypted comparison of the pre-authorization passcode entry information.

A match at lines 386 and 388 of the received Sconfirm from the wireless PD 356 with the Mconfirm from the information handling system 300 and the Sconfirm form the information handling system 300 with the Mconfirm at the wireless PD 356 may be used as verification in such an example embodiment. In other embodiments, an exchange of the pre-authorization passcode entry information generated or stored such as with 374 and 376 may be used as verification of the pairing process. It is appreciated that other verification methods may be used in the present description in order to confirm that each of the wireless PD 356 and information handling system 300 have the pre-authorization passcode entry information and the present specification contemplates these other methods.

In those circumstances where the user does not immediately interact with the GUI to either accept or abort the pairing, the pre-authorization security exchange system 362, at line 380, may send a request for user detection data from the user presence detection system 360. The execution of the computer readable program code of the user presence detection system 360 by a hardware processor causes the user presence detection system 360 to detect whether the user was or is interacting with the information handling system 300. In an embodiment, the user presence detection system 360 receives data from one or more sensors indicative of user presence within a historic threshold time limit prior to receipt of the BT pairing advertisement at 368. In one embodiment, this historic threshold time limit may be set to two minutes such that where the user presence detection system 360 has detected user presence (e.g., user interaction with the information handling system 300) before the BT pairing advertisement at 368 was received or anytime after, the user presence detection system 360 indicates user presence to the pre-authorization security exchange system 362 for up to two minutes before the BT pairing advertisement at 368 was received or at any time at or after the BT pairing advertisement at 368 was received. It is appreciated that the historic threshold time limit may be set to any length of time and the present specification contemplates these other lengths of time.

In an embodiment, the user presence detection system 360 may interact with any type of sensor present within the information handling system 300. These sensors may include any device that detects the presence of the user or detects interactions of the user with the information handling system 300. These sensors include, in an example embodiment, a camera or other presence sensor (e.g., webcam) capable of detecting an image of the user in front of the information handling system 300. The camera or other presence sensor (e.g., webcam) may be operated by a hardware processing resource (e.g., EC, CPU, GPU, and the like) to monitor for a user's presence by, for example, detecting the user's face. In an embodiment, an IR light may be used in low light conditions to detect the user's face with an IR camera and specifically detect that this specific user had previously interacted with the information handling system 300 within a historic threshold time limit (e.g., 2 minutes) before the BT pairing advertisement at 368 or anytime after. Where the user's presence has been detected by the webcam, this interaction data is sent to the user presence detection system 360, at line 380, for the user presence detection system 360 to determine if the user had previously interacted with the information handling system 300 within the historic threshold time limit before the BT pairing advertisement at 368 or anytime after.

In an embodiment, the information handling system 300 may include a motion sensor placed within a housing of the information handling system 300 that detects movement of the information handling system. Movement of the information handling system 300 may indicate that the user is transporting, bumping, or otherwise manipulating the information handling system 300 indicating that the user is interacting with the information handling system 300. Again, this interaction data is sent to the user presence detection system 360 at line 380 for the user presence detection system 360 to determine if the user had previously interacted with the information handling system 300 within the historic threshold time limit before the BT pairing advertisement at 368 or anytime after.

In an embodiment, the information handling system 300 includes a keyboard (e.g., a wired or wireless keyboard) that detects user interaction with the information handling system 300. Because the user provides input to the information handling system 300 by actuating any key on the keyboard, this actuation data may also be used by the user presence detection system 360 to determine if the user had previously interacted with the information handling system 300. Again, this interaction data is received by the user presence detection system 360 at line 380 for the user presence detection system 360 to determine if the user had previously interacted with the information handling system 300 within the historic threshold time limit before the BT pairing advertisement at 368 was received or anytime after. As described herein, other input devices, already operatively coupled to the information handling system 300, such as a wired or wireless mouse, a wired or wireless stylus, a wired or wireless video display device, a wired or wireless trackpad among other input/output devices. Each of these devices or a set of these devices 340 may be used by the user presence detection system 360 to obtain interaction data that is to be received by the user presence detection system 360 for the user presence detection system 360 to determine if the user had previously interacted with the information handling system 300 within the historic threshold time limit or anytime after as described herein.

As described herein, at line 380, this data is provided to the user presence detection system 360, the user presence detection system 360 may determine at line 380 if the user has interacted with the information handling system 300 within the historic threshold time limit or anytime after. Where the user presence detection system 360 has determined that the user interactions was conducted by the user within the threshold time limit, the user presence detection system 360 may signal at line 382 to the pre-authorization security exchange system 362 that the information handling system 300 is to have priority to pair with the wireless PD 356 at line 390. In an embodiment, the pre-authorization security exchange system 362 may signal to the wireless PD 356 that priority is to be given to the information handling system 300 based on the detected user interactions at the information handling system 300. With this priority determined, the system may skip a waiting period to allow for other pairing processes to occur which may have priority or user acceptance from other information handling systems.

In an embodiment, at line 392, the pre-authorization security exchange system 362 may wait for a set period of time to determine if other pairing processes could be completing with nearby information handling systems and priority has not been determined with user presence indication. This time period may be between 1 to 3 seconds in an embodiment and in a specific embodiment this time period is two seconds. This process may occur if and when user presence was not detected within the threshold time limit at lines 380 and 382. At the end of the set period of time, the pre-authorization security exchange system 362 may determine, at line 392, whether the advertisement packet from the wireless PD 356 is still present and, where the advertisement packet is still present, the pre-authorization security exchange system 362 may proceed with the exchange of the pre-authorization passcode entry information.

At line 394, the pre-authorization security exchange system 362 may save this pre-authorization passcode entry information in the memory device 304 for later user by the information handling system 300 to pair the wireless PD 356 to the information handling system 300. In an embodiment, the pre-authorization passcode entry information may be saved on a secure memory device such as a UEFI memory device such that the pre-authorization passcode entry information is accessible to the OS BT stack 366. It is appreciated that any safe data storage device or other memory device (e.g., main memory, static memory, etc.) may be used to temporarily store the pre-authorization passcode entry information prior to the user providing input to accept the pairing of the information handling system 300 to the wireless PD 356.

At line 396, the user may accept the pairing of the wireless PD 356 to the information handling system 300 and the pre-authorization security exchange system 362 then accesses the pre-authorization passcode entry information stored on the memory device 304. Where the user has accepted the pairing, delay for the process of generating the pre-authorization passcode entry information is not experienced by the user because the information handling system 300 and wireless PD 356 had already engaged in this generation thereby reducing the time necessary to complete the paring process. Further, the pre-authorization security exchange communication between the information handling system 300 and wireless PD 256 may have already begun in some embodiments further saving delay. As described herein, the user may have not quickly accepted the pairing process when the GUI was displayed on the video display device 344. Although the user was present and interacting with the information handling system 300 according to the user presence detection system 360, the quick acceptance may not have occurred because, for example, the user has stepped away from the information handling system 300. When the user returns or otherwise is able to interact with the GUI to accept the pairing, the pre-authorization security exchange system 362 access the pre-authorization passcode entry information for quick pairing between the wireless PD 356 and the information handling system 300. This method and system, therefore, allows for the immediate generation and storage of the pre-authorization passcode entry information, and even to commencement of pre-authorization communication exchange in some embodiments, when a user input is not received. Thus, the immediate generation of the pre-authorization passcode entry information where the user is slow to accept the pairing occurs so that the slow acceptance does not delay the process.

At line 397, the pairing process is completed with the exchange of the now finalized pre-authorization passcode entry information which is held by both the information handling system 300 and the wireless PD 356. Where the values match, the BT pairing process is successful at line 398 and the information handling system, upon receipt of the user pairing acceptance will issue a pairing request. Upon doing so, the information handling system 300 and wireless PD 356 establish a session key at line 399 under the BT protocols. In an embodiment, the communication between the information handling system 300 and wireless PD 356 is established via a BT wireless link via the OS BT stack using BT protocols by the BT radios of the information handling system 300 and wireless PD 356. Although the present specification describes specific pairing processes being used after the user has provided input to accept the pairing of the wireless PD 356 to the information handling system 100, the present specification contemplates that other and/or additional processes may be used to complete the pairing process as described herein. Once paired, the user may operate the wireless PD 356 to provide input and receive output from the information handling system 300.

In an embodiment, at line 397, the information handling system 300 and the wireless PD 356 may exchange input and output (I/O) capabilities via BT wireless radios. This is done so as to automate the pairing process. In an example embodiment, the information handling system 300 may provide information that they have, as an input device, a keyboard while the mouse (the wireless PD 356 in this example embodiment) includes a display device. Although the mouse does not include a display device, this allows for automatic pre-authorization passcode entry information entry paring at the information handling system 300.

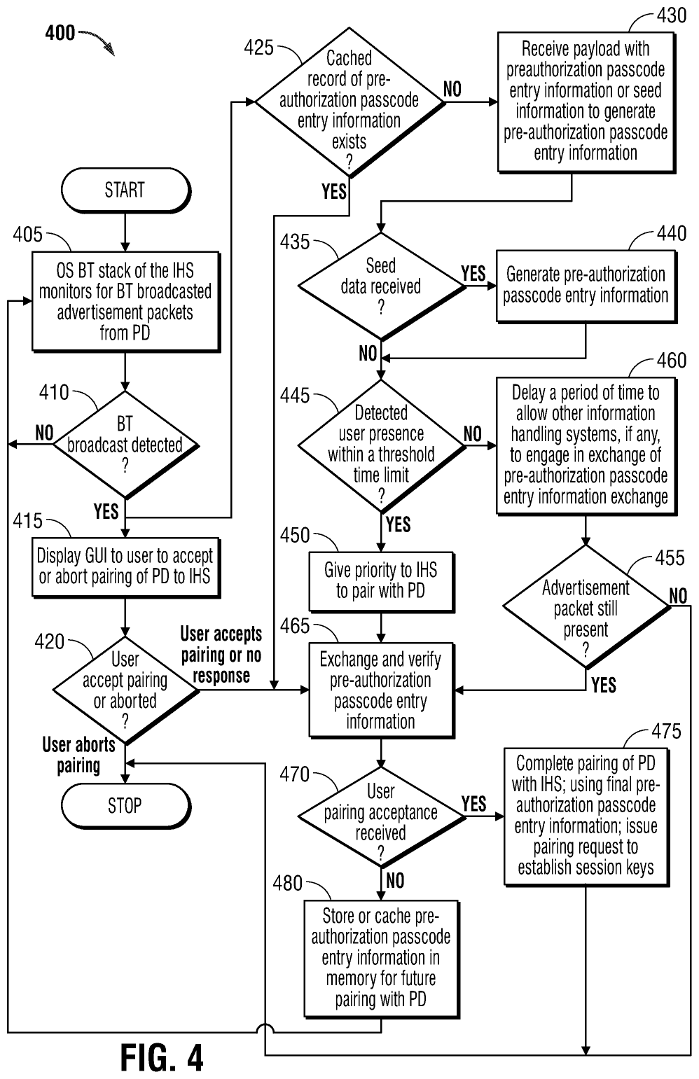

FIG. 4 is a process flow diagram of a method 400 of automatically querying, verifying, and Bluetooth® pairing a wireless PD to an information handling system using the pre-authorization security exchange system according to an embodiment of the present disclosure. The method 400 may begin at block 405 with the OS BT stack executing with a wireless BT radio and controller or processor of an information handling system monitoring for a BT broadcasted advertisement packet from a wireless PD. This monitoring may be continuous or may include timed monitoring sessions executed by the OS BT stack to monitor for BT broadcasts from a wireless PD. At block 410, the OS BT stack, being controlled by a hardware processor or controller of a BT wireless radio, makes a determination as to whether the BT broadcast has been detected at the OS BT stack. Where a BT broadcast has not been detected, the method 400 continues back to block 405 with the OS BT stack monitoring for a BT broadcast. Where a BT broadcast is detected at block 410, the method 400 continues to block 415.

At block 415, the OS Bluetooth® stack sends instructions to a video display device of the information handling system to display a GUI providing a user the option to accept or abort the pairing process now initiated by the broadcast by the wireless PD. The GUI displayed at block 415 may include any visual indicator that requests the user to either accept or abort the pairing process between the information handling system and the wireless PD. This display device may be presented to the user so long as the broadcast from the wireless PD is detected at block 410. At block 420, a determination is made as to whether the user has accepted or aborted the pairing process or if a decision is still pending and no response has yet been received. Where, at block 420, input is received from the user at the information handling system indicating that the pairing process is to be aborted, the method 400 may end. Where the user, at block 420, input is received from the user at the information handling system indicating that the pairing process is accepted or that no response is received, the method 400 continues to block 465 as described herein.

Additionally, a parallel process may be conducted while input from the user at block 420 is being determined. At block 425, once a BT pairing broadcast advertisement is detected the pre-authorization security exchange system of the information handling system 300 may determine whether a cached or stored pre-authorization passcode entry information associated with the wireless PD being paired with the information handling system 300 is present. As described herein, the wireless PD having previously broadcasted a pairing request to the information handling system may have included seed information in payload that may be used or have been used previously in the automatic generation of the pre-authorization passcode entry information. However, in this example, the pairing process was not previously accomplished and, per the systems and methods described herein, the pre-authorization passcode entry information would have been stored or cached on the information handling system for a potential later pairing in a retry that occurs before the cached pre-authorization passcode entry information is purged. Where, at block 425, it is determined that the pre-authorization passcode entry information exists on a storage device on the information handling system, the method 400 may continue to block 465 for the pre-authorization security exchange to conduct a pre-authorization security communication to exchange of the pre-authorization passcode entry information for verification that matching data is with the information handling system as well as the wireless PD to authorize pairing pending acceptance of the pairing by the user. Then at block 470, with the determination that pairing is authorized or verified via the pre-authorization security communications, the pre-authorization security exchange may make a determination whether the user has accepted the pairing within a timeout time threshold.

Where, at block 425, it is determined that the pre-authorization passcode entry information does not exist on a storage device on the information handling system, the method 400 may continue to block 430 with the pre-authorization security exchange system receiving the payload with the pre-authorization passcode entry information or seed information used. The pre-authorization passcode entry information received directly from payload in an embodiment may be sent to the OS BT stack at the BT wireless radio and stored in memory there to prepare for pre-authorization security exchange communication. In other embodiments, the seed data received in payload may be used to generate the pre-authorization passcode entry information with a processor executing code instructions of the pre-authorization security exchange system. The pre-authorization passcode entry information is sent to the BT OS stack and stored and corresponds to that generated or saved at the wireless PD. As described herein, the wireless PD may broadcast as part of the payload the pre-authorization passcode entry information used by the information handling system to be paired with each other. However, in order to increase the security between the information handling system and wireless PD, the wireless PD may broadcast a seed value or random number value used with code instructions to execute a hash function or other function to generate the pre-authorization passcode entry information as described below.

At block 435, the pre-authorization security exchange system may determine whether it was the seed data that was received instead of the pre-authorization passcode entry information at the information handling system. Where the seed data is received instead of the pre-authorization passcode entry information at block 435, the method 400 continues with the pre-authorization security exchange system using the seed data (e.g., random number, etc.) and execute code instructions of a hash function or other function known to the information handling system to generate the pre-authorization passcode entry information. Concurrently, a microcontroller or other hardware processing device on the wireless PD may use the seed data to derive a matching pre-authorization passcode entry information if not directly saved at the wireless PD. The flow may then proceed to block 445. Where, instead, it was the pre-authorization passcode entry information that was broadcasted directly to the information handling system 300 at block 435 in payload of the BT wireless pairing advertisement, the method 400 continues to block 445.

As described herein, at block 445, the method 400 includes determining whether user presence has been detected within a historic threshold time limit prior to receiving the BT wireless pairing advertisement or detected at or after receiving the same. In an embodiment, the pre-authorization security exchange system described herein instructs a hardware processor to execute computer readable program code of a user presence detection system. The execution of the computer readable program code of the user presence detection system causes the user presence detection system to detect whether the user was or is interacting with the information handling system. In an embodiment, the user presence detection system receives data from one or more sensors indicative of user presence within a threshold time limit. In an embodiment, this threshold time limit may be set to two minutes such that where the user presence detection system has detected user presence (e.g., user interaction with the information handling system), the user presence detection system indicates user presence to the pre-authorization security exchange system.

In an embodiment, the user presence detection system may interact with any type of sensor present within the information handling system. These sensors may include any device that detects the presence of the user or detects interactions of the user with the information handling system. These sensors include, in an example embodiment, a camera or other presence sensor (e.g., a webcam) capable of detecting an image of the user in front of the information handling system. The camera or other presence sensor (e.g., a webcam) may be operated by a hardware processing resource (e.g., EC, CPU, GPU, and the like) to monitor for a user's presence by, for example, detecting the user's face. In an embodiment, other cameras or sensors may include an infrared (IR) light may be used in low light conditions to detect the user's face and specifically detect that this specific user had previously interacted with the information handling system within a threshold time limit (e.g., 2 minutes). Where the user's presence has been detected by the webcam, this interaction data is sent to the user presence detection system for the user presence detection system to determine if the user had previously interacted with the information handling system within the historic threshold time limit before, at or after receipt of the BT wireless pairing advertisement.

In an embodiment, the information handling system may include other cameras or sensors such as a motion sensor placed within a housing of the information handling system that detects movement of the information handling system. Movement of the information handling system may indicate that the user is transporting, bumping, or otherwise manipulating the information handling system indicating that the user is interacting with the information handling system. Again, this interaction data is sent to the user presence detection system for the user presence detection system to determine if the user had previously interacted with the information handling system within the historic threshold time limit before receipt of the BT wireless pairing advertisement or any interaction at or afterward.

In an embodiment, the information handling system includes a keyboard (e.g., a wired or wireless keyboard) that detects user interaction with the information handling system. Because the user provides input to the information handling system by actuating any key on the keyboard, this actuation data may also be used by the user presence detection system to determine if the user had previously interacted with the information handling system. Again, this interaction data is received by the user presence detection system for the user presence detection system to determine if the user had previously interacted with the information handling system within the historic threshold time limit before receipt of the BT wireless pairing advertisement or any interaction at or afterward. As described herein, other input devices, already operatively coupled to the information handling system, such as a wired or wireless mouse, a wired or wireless stylus, a wired or wireless video display device, a wired or wireless trackpad among other input/output device. Each of these devices or a set of these devices may be used by the user presence detection system to obtain interaction data that is to be received by the user presence detection system for the user presence detection system to determine if the user had previously interacted with the information handling system within the historic threshold time limit before receipt of the BT wireless pairing advertisement or any interaction at or afterward as described herein.

Where user presence has not been detected at block 445, the method 400 may continue to block 460. At block 460, the pre-authorization security exchange system may delay for a period of time, such as a 2-3 second delay period, pending other information handling systems within broadcasting range of the wireless PD have an opportunity to be allowed to engage in the exchange of the pre-authorization passcode entry information (or seed data) as described herein. As such, although the wireless PD is eventually wirelessly paired with an information handling system, the wireless PD may distribute the pre-authorization passcode entry information (or seed data) to a plurality of nearby information handling systems with each of these nearby information handling systems also storing the pre-authorization passcode entry information as indicated at block 425. At block 455, the information handling system to which the pre-authorization passcode entry information was received may have waited for the delay period of time before determining whether an advertisement is still present to determine if pairing with the wireless PD is still an option for this information handling system. Where the advertisement packet from the wireless PD 356 is still present, the method may continue to block 465 to conduct pre-authorization security exchange communication for pairing verification and authorization. Where the advertisement packet is no longer present because other nearby information handling systems had been paired with the wireless PD, the method 400 may stop and pairing with the original information handling system is not completed.

Where the user presence has been detected referring back to block 445, pairing priority is given to the information handling system originally being paired with the wireless PD at block 450. This pairing priority, in one embodiment, assures that the information handling system will be given preference for pairing over other potential information handling systems within the vicinity to receive the BT broadcast from the wireless PD. In this case the delay time period is not held by the pre-authorization security exchange system and the flow proceeds to block 465 for pre-authorization security exchange communication for pairing verification and authorization communications as described. In such a case, the system may further shorten the pairing time by eliminating the delay time period in some embodiments.

When pairing priority has been given to the information handling system at block 450 the method 400 proceeds with exchanging and verifying the pre-authorization passcode entry information at block 465 via a pre-authorization security exchange communication. Again, this may include a wireless protocol that secures data between the wireless PD and the information handling system as each provide encrypted versions of the pre-authorization passcode entry information to each other in order to compare the pre-authorization passcode entry information data at the information handling system and the wireless PD according to various embodiments described herein. If they match, wireless pairing between the information handling system and the wireless PD may be verified and authorized pending acceptance of the pairing by a user if one has not already been received. Flow may then proceed to block 470.

At block 470, the pre-authorization security exchange system may determine whether the user has accepted the pairing process or not before a timeout threshold has been reached. Thus, while the information handling system is awaiting user input indicating whether to pair (“accept”) the wireless PD with the information handling system or not (“abort”) at block 470 via the GUI presented by the pre-authorization security exchange system, this pre-authorization passcode entry information may have already been generated. Further, in some embodiments, the pre-authorization security exchange communications, as discussed in block 465, for authorization of the pairing may have begun between the information handlings system and the wireless PD while pending receipt of acceptance by the user. Where the user has not accepted the pairing process within a timeout time limit, the pre-authorization passcode entry information may be saved or cached on a secure memory device such as a unified extensible firmware interface (UEFI) memory device at block 480. It is appreciated that any safe data storage device or other memory device (e.g., main memory, static memory, etc.) may be used to temporarily store the pre-authorization passcode entry information prior to the user providing input to accept the pairing of the information handling system to the wireless PD. Saving this pre-authorization passcode entry information may itself be limited and purged after a time period as well that may be longer than the timeout period threshold to allow for a retry with the wireless PD. This purge time limitation may be any duration but may, in one example embodiment, be 2-5 minutes. The pre-authorization passcode entry information is cached and saved for a later retry if one occurs within the limited purge period of time limitation when no acceptance decision is received.

However, where it is determined by the pre-authorization security exchange system that the user has accepted the pairing of the information handling system with the wireless PD at block 470 the pairing of the wireless PD with the information handling system is completed using the generated and final pre-authorization passcode entry information generated previously by the pre-authorization security exchange system. The pre-authorization security exchange system may conduct or finalize the pre-authorization security exchange communication, such as described at block 465, between the information handling system and the wireless PD to determine that each side has a pre-authorization passcode entry information that match each other. If so, then the pairing process may then proceed under the BT protocols to request and establish a session key.

At block 475, upon receiving the user acceptance of the pairing by the pre-authorization security exchange system, the wireless BT radio of the information handling system may then issue a BT pairing request that it is authorized to pair with the wireless PD under the BT pairing protocols. Upon such authorization and a request issued, the BT radios at the information handling system and at the wireless PD may generate and establish a session key under the BT protocol to exchange IO data and the pairing process is completed. At this point, the method 400 may end.

It is appreciated that the user may abort the pairing process at block 420 which causes the method 400 to end with the wireless PD not being paired with the information handling system. However, the user may also be present to accept the pairing process at block 420. Where the user has accepted, the method continues with the generation of the pre-authorization passcode entry information at block 440 as described herein. However, because the generation of the pre-authorization passcode entry information had already been started or even completed, the amount of time that it may take to eventually pair the wireless PD to the information handling system is shorter.

The blocks and steps of the flow diagrams of FIGS. 4 and 5 or steps and aspects of the operation of the embodiments herein and discussed above need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system comprising:
a hardware processor;
a memory device;
a power management unit (PMU) to provide power to the hardware processor and memory device;
the hardware processor executing computer readable program code of a user presence detection system to detect interactions of a user with the information handling system via a sensor or input/output device to determine a pairing priority;
the hardware processor executing computer readable program code of a pre-authorization security exchange system to communicate with a wireless peripheral device to receive pre-authorization passcode entry information via a payload of a wireless Bluetooth® (BT) pairing advertisement and to initiate a security exchange communication to authorize a BT pairing between the wireless peripheral device with the information handling system while user input to the information handling system to accept the BT pairing with the wireless peripheral device is pending to shorten the duration of the BT pairing;
the pre-authorization security exchange system to store the pre-authorization passcode entry information in the memory device; and
a wireless interface adapter initiating BT pairing via a BT protocol with the wireless peripheral device upon receipt of the user input to accept the pairing with the wireless peripheral device.

2. The information handling system of claim 1 further comprising:
the hardware processor executing computer readable program code of the user presence detection system to detect the presence of a user operating the information handling system to determine that the user has interacted with the information handling system within a historic threshold time limit prior to receiving the BT pairing advertisement and to commence pre-authorization security exchange communication with a wireless peripheral device without delay for other potential pairing information handling systems.

3. The information handling system of claim 1 wherein upon detection that the user has interacted with the information handling system within the historic threshold time limit and input from the user has not been received yet indicating that pairing the information handling system with the wireless peripheral device is accepted, the pre-authorization security exchange system stores the pre-authorization passcode entry information in the memory device for later use upon a retry to pair with the wireless peripheral device.

4. The information handling system of claim 2 wherein upon detection that the user has interacted with the information handling system within the historic threshold time limit and input from the user has indicated that pairing the information handling system with the wireless peripheral device is accepted, the pre-authorization security exchange system determines whether the stored pre-authorization passcode entry information at the information handling system matches with a counterpart pre-authorization passcode entry information at the wireless peripheral device to authorized BT pairing.

5. The information handling system of claim 1 further comprising:
the hardware processor executing the pre-authorization security exchange system to access the detected interactions of a user and if no interaction of the user within the historic threshold time limit, instituting a delay period at the information handling system before initiation of pre-authorization security exchange communication with the wireless peripheral device for authorization of BT pairing.

6. The information handling system of claim 1 further comprising:
the pre-authorization security exchange system requesting for and detecting a received signal strength indicator (RSSI) from the wireless peripheral device to determine whether the wireless peripheral device is within a threshold distance from the information handling system to conduct the pre-authorization security exchange communication with a wireless peripheral device and BT pairing of the wireless peripheral device with the information handling system.

7. The information handling system of claim 1 further comprising:
the pre-authorization security exchange system conducting the security exchange communication to determine a match of the pre-authorization passcode entry information at the information handling system with a counterpart pre-authorization security exchange communication at the wireless peripheral device in parallel with an automatic peripheral device pairing agent displaying, on a video display device of the information handling system, a graphical user interface (GUI) presenting options for the user to input the indication of accepting the pairing of the wireless peripheral device with the information handling system or aborting the pairing of the wireless peripheral device.

8. The information handling system of claim 1 further comprising:
the memory device including a secure data storage device associated with a Bluetooth® stack executing on the wireless interface adapter of the information handling system for storing the pre-authorization passcode entry information.

9. An information handling system comprising:
a hardware processor;
a memory device;
a power management unit (PMU) to provide power to the hardware processor and memory device;
the hardware processor executing computer readable program code of a pre-authorization security exchange system to communicate with a wireless peripheral device to receive seed data for a pre-authorization passcode entry information via a payload of a wireless Bluetooth® (BT) pairing advertisement and to generate the pre-authorization passcode entry information from the received seed data while user input to the information handling system to accept a BT pairing with the wireless peripheral device is pending to shorten the duration of the BT pairing;
the pre-authorization security exchange system to store the pre-authorization passcode entry information in the memory device;
a wireless interface adapter to conduct a pre-authorization security exchange communication with the wireless peripheral device to determine if the pre-authorization passcode entry information matches a counterpart pre-authorization passcode entry information stored at the wireless peripheral device to authorize a BT pairing with the wireless peripheral device; and
the wireless interface adapter initiating BT pairing via a BT protocol with the wireless peripheral device upon receipt of the user input to accept the pairing with the wireless peripheral device.

10. The information handling system of claim 9 wherein the wireless interface adapter commences the pre-authorization security exchange communication with the wireless peripheral device to determine if the pre-authorization passcode entry information matches the counter-part pre-authorization passcode entry information stored at the wireless peripheral device before receiving input from the user to indicate that the BT pairing the information handling system with the wireless peripheral device is accepted when the information handling system is determined to have priority to pair upon detection of a user interaction with the information handling system within a historic threshold time limit prior to receipt of the wireless BT pairing advertisement.

11. The information handling system of claim 9 wherein the wireless interface adapter commences the pre-authorization security exchange communication with the wireless peripheral device to determine if the pre-authorization passcode entry information matches the counter-part pre-authorization passcode entry information stored at the wireless peripheral device after a delay period and if the wireless BT pairing advertisement is still present after the delay period.

12. The information handling system of claim 9 further comprising:
the hardware processor executing the pre-authorization security exchange system to access the detected interactions of the user with the information handling system determined from a motion sensor, a camera, or an input output device to determine priority of the information handling system to BT pair with the wireless peripheral device.

13. The information handling system of the claim 9 further comprising:
the pre-authorization security exchange system requesting for and detecting a received signal strength indicator (RSSI) from the wireless peripheral device to determine whether the wireless peripheral device is within a threshold distance from the information handling system to conduct the pre-authorization security exchange communication between the wireless peripheral device and the information handling system.

14. The information handling system of claim 9 further comprising:
the pre-authorization security exchange system generating the pre-authorization passcode entry information from seed data received from the wireless peripheral device in parallel with an automatic peripheral device pairing agent displaying, on a video display device of the information handling system, a graphical user interface (GUI) presenting options for the user to input the indication of accepting the BT pairing of the wireless peripheral device with the information handling system or aborting the BT pairing with the wireless peripheral device.

15. The information handling system of claim 9 further comprising:
the memory device including a secure data storage device associated with a Bluetooth® stack executing at processing resources at the wireless interface adapter of the information handling system to store the pre-authorization passcode entry information generated from the received seed data.

16. An information handling system comprising:
a hardware processor;
a memory device;
a power management unit (PMU) to provide power to the hardware processor and memory device;
the hardware processor executing computer readable program code of a pre-authorization security exchange system to communicate with a wireless peripheral device to receive a data payload for a pre-authorization passcode entry information via a wireless Bluetooth® (BT) pairing advertisement and to commence a pre-authorization security exchange communication to determine if the passcode entry information received matches a counterpart pre-authorization passcode entry information stored at the wireless peripheral device to authorize a BT pairing with the wireless peripheral device while user input to the information handling system to accept the BT pairing with the wireless peripheral device is pending from the user to shorten the duration of the BT pairing;
the pre-authorization security exchange system to store the pre-authorization passcode entry information in the memory device; and
the wireless interface adapter initiating BT pairing via a BT protocol with the wireless peripheral device upon receipt of the user input to accept the pairing with the wireless peripheral device.

17. The information handling system of claim 16 wherein the wireless interface adapter commences the pre-authorization security exchange communication with the wireless peripheral device to determine if the pre-authorization passcode entry information matches the counterpart pre-authorization passcode entry information stored at the wireless peripheral device before receiving input from the user to indicate that the BT pairing the information handling system with the wireless peripheral device is accepted when the information handling system is determined to have priority to pair upon detection of a user interaction with the information handling system within a historic threshold time limit prior to receipt of the wireless BT pairing advertisement.

18. The information handling system of claim 16 further comprising:
the hardware processor executing the pre-authorization security exchange system to access detected interactions of the user with the information handling system determined from a motion sensor, a camera, or an input output device to determine priority of the information handling system to BT pair with the wireless peripheral device.

19. The information handling system of the claim 16 further comprising:
the pre-authorization security exchange system requesting for and detecting a received signal strength indicator (RSSI) from the wireless peripheral device to determine whether the wireless peripheral device is within a threshold distance from the information handling system before commencing the pre-authorization security exchange communication between the wireless peripheral device and the information handling system.

20. The information handling system of claim 16 further comprising:
the pre-authorization security exchange system generating the pre-authorization passcode entry information from seed data received in the data payload of the wireless BT pairing advertisement from the wireless peripheral device in parallel with an automatic peripheral device pairing agent displaying, on a video display device of the information handling system, a graphical user interface (GUI) presenting options for the user to input the indication of accepting the BT pairing of the wireless peripheral device with the information handling system or aborting the BT pairing with the wireless peripheral device.
